(19) United States
(12) Patent Application Publication
(10) Pub. No.: US 2007/0186418 A1
(43) Pub. Date: Aug. 16, 2007

(54) Method for manufacturing a hearing device and a use of the method

(76) Inventors: Hilmar Meier, Zurich (CH); Andi Vonlanthen, Remetschwil (CH)

Correspondence Address: PEARNE & GORDON LLP, 1801 EAST 9TH STREET, SUITE 1200, CLEVELAND, OH, 44114-3108, US

(21) Appl. No.: 11/365,339

(22) Filed: Mar. 1, 2006

(30) Foreign Application Priority Data
Feb. 10, 2006 (EP) 06 101 538.4

(51) Int. Cl. B29D 17/00; H04R 31/00

(52) U.S. Cl. 29/896.2; 29/896.21

(57) ABSTRACT

A method for manufacturing a hearing device (10) that is at least partially insertable into a hearing device user's ear canal (7), the hearing device (10) comprising at least two microphones or at least one microphone with two entry ports, the method comprising the steps of:
determining a three-dimensional structure of a hearing device user's ear canal (7), deriving shape of the hearing device based on said three-dimensional structure,
defining an outer surface (11) of the hearing device (10) to further define the shape of the hearing device (10), said outer surface (11) pointing towards surroundings when the hearing device (10) is inserted into the user's ear (1),
positioning openings (13, 14) in said outer surface (11), said openings (13, 14) being in communication with sound inlets of said microphones,
   wherein the step of positioning said openings (13, 14) is performed after defining the outer surface (11), and wherein said positioning is optimized in such a manner that a maximum directional selectivity and noise performance of the microphones is obtained.

### TECHNICAL FIELD

The present invention is related to a method for manufacturing a hearing device as well as to a use of the method.

### BACKGROUND OF THE INVENTION

Today's hearing devices are often equipped with a multi-microphone system in order to provide to the hearing device user with improved perception of sound including its direction of arrival.

At present, manufacturing such multi-microphone hearing device implies solutions for a number of conflicts, as for example the use of an optimal distance between the microphones.

It is well known that directional intelligibility is optimal when the distance between two microphones is in a range from 10 to 14 mm. Such a distance is not implementable if a hearing device of the type ITE—(in-the-ear) or CIC—(completely-in-the-canal) is used, since these devices have a small lateral part, i.e. the visible part of a hearing device when inserted into the hearing device user's ear, which lateral part is never large enough to be able to position two microphones 10 to 14 mm apart. In fact, the distance between microphones is actually a fraction of the above-mentioned optimal distance.

In order to obtain a simple fitting procedure for a hearing device, the distance between microphones—or acoustic inlets, which lead to the microphones—is standardized and exhibits a fixed distance. Even if the shell of a hearing device is adapted to the individual shape of a hearing device user's ear canal, standardized microphone modules with pre-mounted microphones are used. For a custom-made hearing device, the microphone module containing the pre-mounted multiple microphones is simply positioned on the lateral part of the individually manufactured shell, and the internal adjustment can simply be performed under the standardized conditions particularly resulting from the fixed distance between the microphones.

In order to allow a multi-microphone module to be positionable in a wide range of ear canal cross-sections, the multi-microphone module is available in dimensions, which are well below average. Therewith, it is guaranteed that the multi-microphone module is widely applicable, i.e. it can readily be used for many custom-made hearing devices.

The major disadvantage of this known technique results from the rather small distance between the microphones, leading to a poor performance of the overall hearing device, in particular with respect to its directional selectivity and noise performance.

It is therefore an object of the present invention to at least overcome the above-mentioned disadvantage and to provide for an improved method for manufacturing a hearing device.

### SUMMARY OF THE INVENTION

The present invention is related to a method for manufacturing a hearing device that is at least partially insert-able into a hearing device user's ear canal, the hearing device comprising at least two microphones or at least one microphone with two entry ports, the method comprising the steps of:
determining a three-dimensional structure of a hearing device user's ear canal,
deriving shape of the hearing device based on said three-dimensional structure,
defining an outer surface of the hearing device to further define the shape of the hearing device, said outer surface pointing towards surroundings when the hearing device is inserted into the user's ear,
positioning openings in said outer surface, said openings being in communication with sound inlets of said microphones,
   wherein the step of positioning said openings is performed concurrently (e.g. in cases where an iterative process is applied to define the outer surface) or after defining the outer surface, and wherein said positioning is optimized in such a manner that a maximum directional selectivity of the microphones is obtained.

Therewith, the individual three-dimensional structure is taken into account while positioning the openings and microphones, respectively, giving the possibility to find the optimal position for the openings and/or microphones to improve the directional intelligibility and the noise performance.

It is expressly pointed out that the term “microphone” may also mean just one of two entry ports of a single acoustic-electric converter, since a directional acoustic-electric converter can be constructed from a single acoustic-electric converter with two entry ports or by combining the electrical outputs from two (or more) acoustic-electric converters.

Furthermore, it is pointed out that throughout this specification the term “hearing device” is to be understood as a device, be it implantable or not, to improve hearing ability, either of a hearing impaired person or of a normal hearing person, or as a communication device or the like.

In a further embodiment of the present invention, the optimizing is performed by maximizing a distance between two openings in the outer surface.

In a further embodiment of the present invention, at least two openings are positioned in such a manner that a line defined by the at least two openings and a horizontal plane enclose an angle that is within a range of approximately ±20 degrees, the exact value being determined by the directional characteristics of the beamformer.

In a still further embodiment of the present invention, at least two openings are positioned in such a manner that a line defined by the at least two openings and a vertical plane enclose an angle that is within a range of ±15 degrees.

A still further embodiment of the present invention comprises the step of positioning the microphones directly at said openings.

A still further embodiment of the present invention comprises the step of selecting a microphone type or types out of a number of possible microphone types, the selection being performed on the basis of available space at the openings. Therewith, the inventive aspect is included that the two or more microphones can be of different type and style.

A still further embodiment of the present invention comprises the step of positioning a further opening on a connecting line of at least two other openings.

A still further embodiment of the present invention comprises the step of adjusting parameters and/or algorithms in the hearing device taking into account the distance between the openings.

Furthermore, a use of the method for manufacturing a hearing device can be employed to manufacture a left and a right hearing device of a binaural hearing system.

In such a binaural hearing system, the distances between openings for the left hearing device may be equal or unequal to the distances between openings for the right hearing device.

### BRIEF DESCRIPTION OF THE DRAWINGS

FIG. 1 shows an anterior view of the external ear in a partial cross-section, a hearing device being inserted into the ear;

FIG. 2 shows a lateral view of the external ear of FIG. 1 with an inserted hearing device known in the art;

FIG. 3 shows a lateral view of the external ear as in FIG. 2 with a hearing device manufactured according to one embodiment of the present invention;

FIG. 4 shows a lateral view of the external ear as in FIG. 3 with a hearing device manufactured according to a further embodiment of the present invention;

FIG. 5 schematically shows a top view of a hearing device user's head;

FIG. 6 shows a lateral view of the external ear as in FIG. 3 with a hearing device comprising three openings manufactured according to a third embodiment of the present invention; and

FIG. 7 shows a lateral view of the external ear as in FIG. 3 with a hearing device comprising three openings manufactured according to a fourth embodiment of the present invention.

### DETAILED DESCRIPTION OF THE INVENTION

In FIG. 1, an external ear 1 of a hearing device user is depicted, the ear 1 being partly in a cross-sectional view in order to also visualize the shape of the ear canal 7, extending from the cavum-concha 4 to the eardrum 6, and its various neighboring parts, of which the helix 3, the lobule 2 and the cavum-concha 4 are also clearly visible from the outside.

For the hearing devices which are inserted into the ear canal 7, as for example the so-called ITE—(In-The-Ear) or the CIC—(Completely-In-The-Canal) hearing devices, the individual shape of the ear canal 7 is most important in order to achieve the highest possible wearing comfort for the hearing device user. In fact, this part of the ear is very susceptible to any pressure due to a shell that is badly adapted to the actual shape of the ear canal 7.

Therefore, one of the important steps of manufacturing a hearing device is to exactly determine the three-dimensional structure of the ear canal 7, in particular in the range in which the hearing device will later be positioned. A known technique for determining the three-dimensional structure of an ear canal is disclosed in US 2003/139 658 A1, for example.

After the three-dimensional structure is determined of the individual ear canal 7, the main part (i.e. the cylindrical part) of the hearing device is derived from the three-dimensional structure. In a next step, which further defines the hearing device housing, an outer surface 11 of the hearing device housing is defined. The outer surface 11 is the part of the hearing device housing which points towards surroundings when the hearing device is inserted into the ear. It is also called the lateral part of the hearing device. Finally, an inner surface 12 of the hearing device housing is defined. The inner surface 12 is the part of the hearing device housing which points towards the eardrum 6 when the hearing device is inserted into the hearing device user's ear. It is also called the medial part of the hearing device. The shape of the hearing device housing is herewith completely defined.

In a consecutive step of the known manufacturing process, the components are positioned within the hearing device housing. In addition and most importantly, the openings are defined in the lateral and in the medial part of the hearing device. For a multi-microphone system, as it is the case in the present applications, a predefined microphone module comprising two microphones, for example, is positioned in the lateral part of the housing, i.e. the openings are in communication with the sound inlets of the microphones. Furthermore, a loudspeaker, also called receiver in the technical field of hearing devices, is positioned in the medial part of the hearing device housing as well as a signal processing unit.

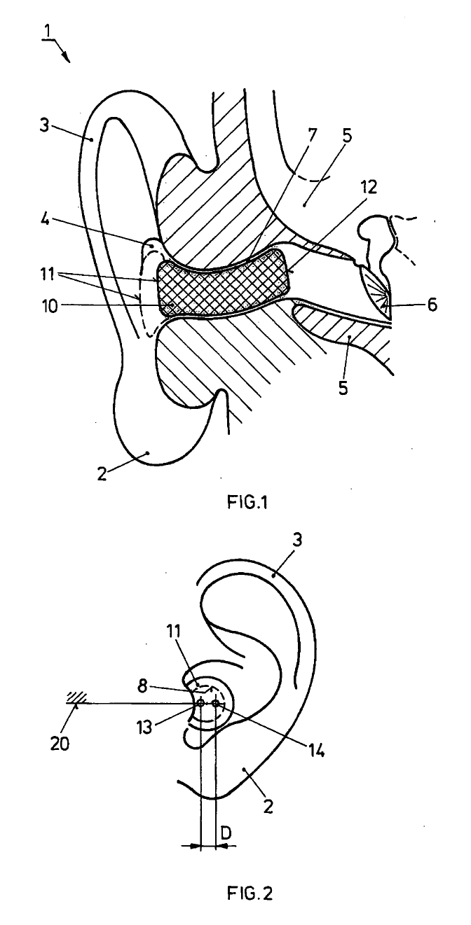

A result of the known techniques is depicted in FIG. 2, which shows a lateral view of the external ear of FIG. 1 with an inserted hearing device. A contour of the ear canal 7 (FIG. 1) lying underneath the outer surface 11 of the hearing device housing is indicated by a dashed line 8, the outer surface 11 completely covering, even overlapping the whole ear canal entry port. The outer surface 11 comprising two openings 13 and 14 being separated by a distance D predefined by the multi-microphone module. The only freedom of configuration for the hearing device designer consists in the orientation of a connecting line between the openings 13 and 14 with respect to a horizontal plane defined by an upright standing hearing device user looking straight forward.

In summary, the known technique for manufacturing a hearing device with multiple microphones consist in that, in a first step, the three-dimensional structure is determined of a hearing device user's ear canal, that, in a second step, the shape of the hearing device is derived based on the three-dimensional structure, and that, in a third step, a multi-microphone module having predefined distances between the microphones is positioned in the outer surface 11.

It has already been pointed out that the hearing device performance is somewhat limited due to the fixed distance between the microphones of the multi-microphone modules.

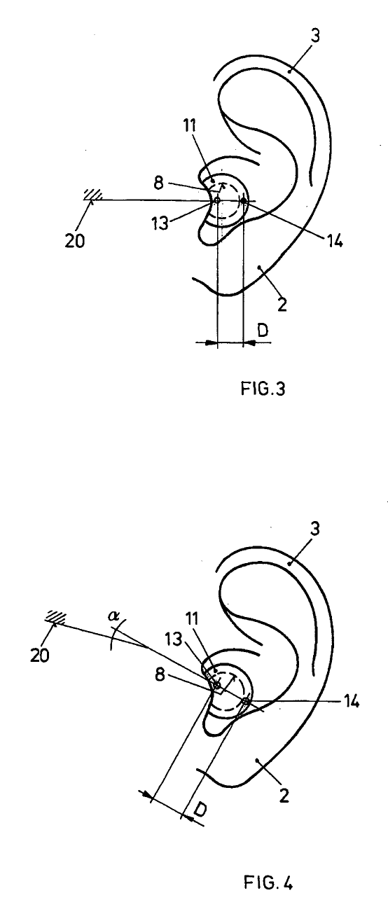

FIG. 3 shows a lateral view of an external ear of a hearing device user. A hearing device, which is manufactured according to the present invention, is inserted into the ear. It becomes very clear from a comparison of FIG. 3 with FIG. 2 that the distance D between the two openings 13 and 14 is much larger for the hearing device manufactured according to the present invention than for the hearing device manufactured according to known art. As a result of the larger distance D for the hearing device of FIG. 3, the directional selectivity and the noise performance are considerably improved.

The inventive method for manufacturing a hearing device, which is at least partially to be inserted into the ear canal, such as for an ITE or a CIC hearing device, the method comprising the steps of:
determining the three-dimensional structure of the hearing device user's ear canal,
deriving the shape of the hearing device based on said three-dimensional structure,
defining the outer surface 11 of the hearing device to further define the shape of the hearing device, and
positioning the openings 13 and 14 in said outer surface 11, the openings 13, 14 being in communication with sound inlets of the microphones.

It is essential for the present invention that the step of positioning the openings 13 and 14 is performed concurrently or after defining the outer surface 11 and that the distance between the openings 13 and 14 is not predefined but is only just fixed in the positioning step. Therewith, it is possible to optimize the position of the openings 13 and 14, and/or the microphones, respectively, in an optimal manner, whereby a considerable improvement is obtained for the directional selectivity of the microphones. In other words, the openings 13, 14 can be positioned independently of each other. The present invention takes into account the large diversity among human beings regarding the three-dimensional structure of the ear, in particular regarding the individual geometry (e.g. cross-sectional area) of the cavum-concha. In the step of optimizing the directional selectivity, information about the individual three-dimensional structure is considered as a constraint, which is to exhaust to its maximum extent during the determination of the positions of the openings 13, 14 and the microphones, respectively.

In one embodiment of the present invention, the distance D between microphones or openings 13, 14, respectively, is maximized within the given individual range of the outer surface 11. While it is generally not possible to realize an ITE or CIC hearing device with a distance D of 10 to 14 mm between the openings 13, 14, much better results are feasible for hearing devices manufactured according to the present invention than for hearing devices incorporating multi-microphone modules generally having a much smaller predefined distance between the microphones.

The distance D is used, in a further step of the inventive method, to adjust the hearing device, in particular, to adjust parameters and/or algorithms that define the behavior of the hearing device in its different operation conditions. Therefore, the distance between microphones is usually stored either in the hearing device itself or in a centralized memory unit that is accessible, e.g. via internet, in order that an audiologist or a software, with which the hearing device is programmed, is provided with adequate information for the calibration and/or fitting process during which the hearing device will be adjusted to the needs of the hearing device user with regard to its operating modes.

In a further embodiment of the present invention, the openings 13, 14 are positioned in such a manner that a line defined by the openings 13, 14 and a horizontal plane, referenced by 20 in FIG. 4, enclose an angle α that is approximately +15 degrees on a scale of 360 degrees for a full angle. The horizontal plane 20 is defined by an upright standing hearing device user looking straight forward. It has been shown that the angle α preferably is within a range of ±20 degrees, more preferably within a range of ±10 degrees.

Similarly, the openings 13, 14 may be positioned in such a manner that the line defined by the openings 13, 14 and a vertical plane 30 enclose an angle θ that is approximately 15 degrees. This is illustrated by FIG. 5 showing a hearing device user's head in a top view. The vertical plane 30 is defined by an upright standing hearing device user looking straight forward. It has been shown that the angle θ preferably is within a range of ±15 degrees, more preferably within a range of ±10 degrees.

Any kind of variance to the horizontal plane can be taken into account by the system, which means, that the microphone inlet distance and the angle to the horizontal plane will be used to calculate the parameters to achieve optimum directivity and noise performance.

It is expressly pointed out that a directional microphone can be constructed from a single microphone with two entry ports or by combining the electrical outputs from two or more microphones. The terms “microphone” and “multi-microphone module” must therefore be understood accordingly, i.e. in a sense that either way of construction is feasible.

In the embodiments discussed above, the positioning of the openings 13, 14 on the outer surface 11 is most crucial to an improvement of the intelligibility. The positioning of the openings 13, 14 is though closely related to the positioning of the microphones within the housing of the hearing device. This is in particular true for embodiments in which no or only a short sound canal is provided between the openings 13, 14 and the corresponding microphone. In fact, minimization of the mentioned sound canal is preferred for preventing any loss of effectiveness.

In a further embodiment of the present invention, selecting a specific microphone type or types out of a number of microphone types is a further step in the inventive method to manufacture a hearing device. This further step allows to further take into account the available space at the openings 13, 14 and to select a microphone type which best fits into this space. As a result, an even more optimized hearing device can be obtained. Possible types of microphones might be definable by its shape, e.g. cylindrical or flat microphones are available.

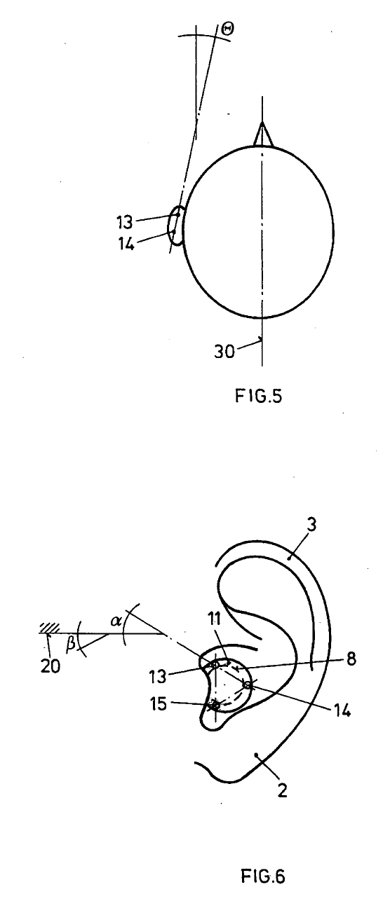

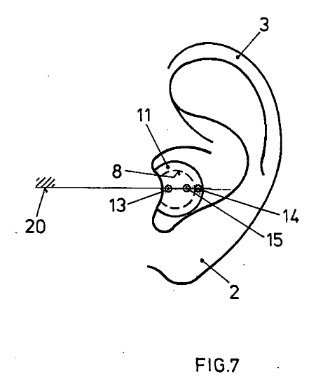

FIGS. 6 and 7 show results of additional embodiments of the present invention. Instead of only two openings 13 and 14, an additional opening 15 in the outer surface 11 is provided for an additional microphone. This opens up a number of further advantageous embodiments that are directed to obtaining a different directional selectivity that directly results from the positions of the openings 13, 14, 15, respectively the corresponding microphones. The inventive method for manufacturing these hearing devices can readily be applied and produce hearing devices, which surpass the overall performance of known hearing devices significantly.

While in the embodiment shown in FIG. 6, the openings 13, 14, 15 constitute a triangle, the openings 13, 14, 15 of FIG. 7 are positioned on a line. The resulting directional sensitivity of the microphones, usually expressed in a polar diagram, will be accordingly.

The present invention can also readily be applied for manufacturing binaural or bilateral hearing devices. Thereby, the openings can either be positioned identically on the left and the right hearing device, or the openings can be positioned individually at the outer surfaces of the left and the right hearing devices. In the latter case, the asymmetric positions of the left and right openings can later be compensated computationally.

Having thus shown and described what is at present considered to be embodiments of the invention, it should be noted that the same has been made by way of illustration and not limitation. Accordingly, all modifications, alterations and changes coming within the spirit and scope of the invention are herein meant to be included.

What is claimed is:

1. A method for manufacturing a hearing device that is at least partially insert-able into a hearing device user's ear canal, the hearing device comprising at least two microphones or at least one microphone with two entry ports, the method comprising the steps of:
determining a three-dimensional structure of a hearing device user's ear canal,
deriving shape of the hearing device based on said three-dimensional structure,
defining an outer surface of the hearing device to further define the shape of the hearing device, said outer surface pointing towards surroundings when the hearing device s inserted into the user's ear,
positioning openings in said outer surface, said openings being in communication with sound inlets of said microphones,
wherein the step of positioning said openings is performed concurrently or after defining the outer surface, and wherein said positioning is optimized in such a manner that a maximum directional selectivity and/or noise performance of the microphones is obtained.

2. The method of claim 1, wherein said optimizing is performed by maximizing a distance between two openings in said outer surface.

3. The method of claim 1, wherein at least two openings are positioned in such a manner that a line defined by the at least two openings and a horizontal plane enclose an angle (α) that is within a range of ±20 degrees.

4. The method of claim 1, wherein at least two openings are positioned in such a manner that a line defined by the at least two openings and a vertical plane enclose a further angle that is within a range of ±15 degrees.

5. The method of claim 1, further comprising the step of positioning the microphones directly at said openings.

6. The method of claim 1, further comprising the step of selecting a microphone type or types out of a number of possible microphone types, the selection being performed on the basis of available space at the openings.

7. The method of claim 1, further comprising the step of positioning a further opening on a connecting line of at least two other openings.

8. The method of claim 2, further comprising the step of adjusting parameters and/or algorithms in the hearing device and/or in the calibration and fitting software, taking into account the distance between the openings.

9. The method of claim 3, further comprising the step of adjusting parameters and/or algorithms in the hearing device and/or in the calibration and fitting software, taking into account the angle to the horizontal plane.

10. The method of claim 4, further comprising the step of adjusting parameters and/or algorithms in the hearing device and/or in the calibration and fitting software, taking into account the further angle to the vertical plane.

11. The method of claim 1, further comprising the step of adjusting parameters and/or algorithms in the hearing device due to a result obtained during the optimizing step.

12. A use of the method of claim 1 for manufacturing a left and a right hearing device of a binaural hearing system.

13. The use of claim 12, wherein distances between openings for the left hearing device are equally adjusted to the distances between openings for the right hearing device.

14. The use of claim 12, wherein the angle between openings and the horizontal plane for the left hearing device are equally adjusted to the angle between openings and the horizontal plane for the right hearing device.

15. The use of claim 12, wherein at least some of the distances between openings for the left hearing device are not equally adjusted to the corresponding distances between openings for the right hearing device.

16. The use of claim 12, wherein at least some of the angle between openings and the horizontal plane for the left hearing device are not equally adjusted to the corresponding angle between openings and the horizontal plane for the right hearing device.
